(19) United States
(12) Patent Application Publication
(10) Pub. No.: US 2020/0116552 A1
(43) Pub. Date: Apr. 16, 2020

(54) Smart Storage Pallet

(71) Applicant: Tak-Nam Wong, New Territories (HK)

(72) Inventor: Tak-Nam Wong, New Territories (HK)

(21) Appl. No.: 16/573,041

(22) Filed: Sep. 17, 2019

Related U.S. Application Data
(60) Provisional application No. 62/744,877, filed on Oct. 12, 2018.
(60) Provisional application No. 62/815,558, filed on Mar. 8, 2019.

(51) Int. Cl. G01G 23/37; B65D 25/04; G01G 21/22; G01G 21/28; G01G 19/52

(52) U.S. Cl. CPC G01G 23/3742; B65D 25/04; G01G 19/52; G01G 21/28; G01G 21/22

(57) ABSTRACT

Disclosed is a Smart Storage Pallet (SSP) for storage containers configured to operate with a Smart Storage and Organizer System (SSOS). The SSOS is implemented with Internet of Things (IoT) technologies, and employs a Bluetooth low energy (BLE) beacon and advanced sensors to track the real-time status and information regarding the contents inside storage containers. The SSP establishes a docking station for the storage containers. The SSOS IoT Bluetooth beacon and appropriate sensors are installed in the SSP. Thereby, the storage containers docked on the SSP are trackable and keeping information and updating the status of the contents inside the storage containers is available through an SSOS network, which includes, (i) mobile phones via the SSOS application (app), (ii) the SSOS controller, and (iii) the SSOS cloud.

### BACKGROUND

The present disclosure relates to household storage containers. More particularly, the present disclosure relates to smart storage containers which communicate with other devices to track and report contents inside the smart storage containers.

Storage containers are useful and essential for storage and organization in domestic and household usage, as well as commercial (e.g. retailers) and industrial (e.g. factories and warehouses) sectors. Nevertheless, it is a common problem that the contents within storage containers are not properly identified and tracked. A user may encounter a situation wherein the user is not able to identify the whereabouts of stored items. There may also be a lack of information regarding an updated status of stored items, such as an expiration date or quality of condition. For example, in household refrigerators, storage containers are commonly used for the storage of foods, yet users are commonly either unaware of and/or forget the existence of the foods in the refrigerator and/or the expiration date of the foods in the refrigerator. Therefore, it has become standard practice for users to routinely search and sort through their refrigerator and freezer contents to throw away expired foods.

Consequently, there exists a need for storage containers equipped with tracking equipment to identify and update the status of the contents within the storage container, the information from which can be accessed through mobile devices.

### SUMMARY

The disclosed Smart Storage Pallet (SSP) for storage containers is configured to operate with a Smart Storage and Organizer System (SSOS) described herein. The SSOS is implemented with state-of-the-art Internet of Things (IoT) technologies, and employs Bluetooth low energy (BLE) beacon and advanced sensors to keep track of the real-time status and information of the contents inside storage containers.

The SSP establishes a docking station for ordinary household storage containers. The SSOS IoT Bluetooth beacon and appropriate sensors are installed in the SSP. Thereby, containers docked on the SSP will become trackable and keeping information and updating the status of the contents inside the containers will become available through the SSOS network, including (i) mobile phones via the SSOS application (app), (ii) the SSOS controller, and (iii) the SSOS cloud. The SSOS for which the SSP has applicability is illustrated by the architecture of FIG. 4.

In one embodiment, an SSP docks a single container. The SSP is equipped with an appropriate type of weight or pressure sensors. The main mechanical structure of the docking station comprises a top plate and a number of soft elastic pads such that each pad is in contact with a weight or pressure sensor. The top plate and a body of the station are preferably made of a hard material such as plastic, wood, or metal. The sensor contact pads preferably are to be made of soft elastic material of hardness of durometer Shore A 45 to 70. The sensing information is processed by the corresponding weight or pressure sensor controller for passing on to the SSOS device. The Bluetooth beacon of the SSOS device then broadcasts the storage description and weight or pressure information to the mobile app and the SSOS controller.

In another embodiment, an SSP docks multiple containers. This station is in the form of a tray for housing multiple containers. The tray may be divided into a number of compartments for accommodating multiple containers. Each compartment is equipped with the appropriate number of weight or pressure sensors (minimum number of weight or pressure sensor is 1) for every compartment. The concept of the mechanical structure is the same as described in the first embodiment.

In another embodiment, an SSP is oriented (attached) within a container and docks stored items (content) directly.

A smart wine rack structure is based on the working principle of the SSP and is employed for docking several bottles of wine.

A smart egg container structure is based on the working principle of the SSP and is employed for docking multiple containers.

A smart pill box structure is based on the working principle of the SSP and is employed for docking multiple containers.

A mobile app handles the sensing information for the SSP with multiple compartments for docking multiple containers.

### BRIEF DESCRIPTION OF THE DRAWINGS

FIG. 1A is a perspective view of a platform-type SSP;

FIG. 1B is a side elevational view of a container located on the top of the platform-type SSP of FIG. 1A;

FIG. 2A is a perspective view of a tray-type SSP with an SSP station being divided into a number of partitions which are employable for receiving items such as eggs, spice bottles, pill containers, make-up items, etc.;

FIG. 2B is a perspective view of a tray-type SSP with multiple containers seated on an SSP station;

FIG. 2C is a perspective view of a tray-type SSP configured as a smart wine rack to track and monitor the status of several bottles;

FIG. 3 is an exploded perspective view of an SSP;

FIG. 4 is a schematic view of architecture for a representative SSOS employed in conjunction with the SSP; and

FIG. 5 is a perspective view of an SSP within a container.

### DETAILED DESCRIPTION

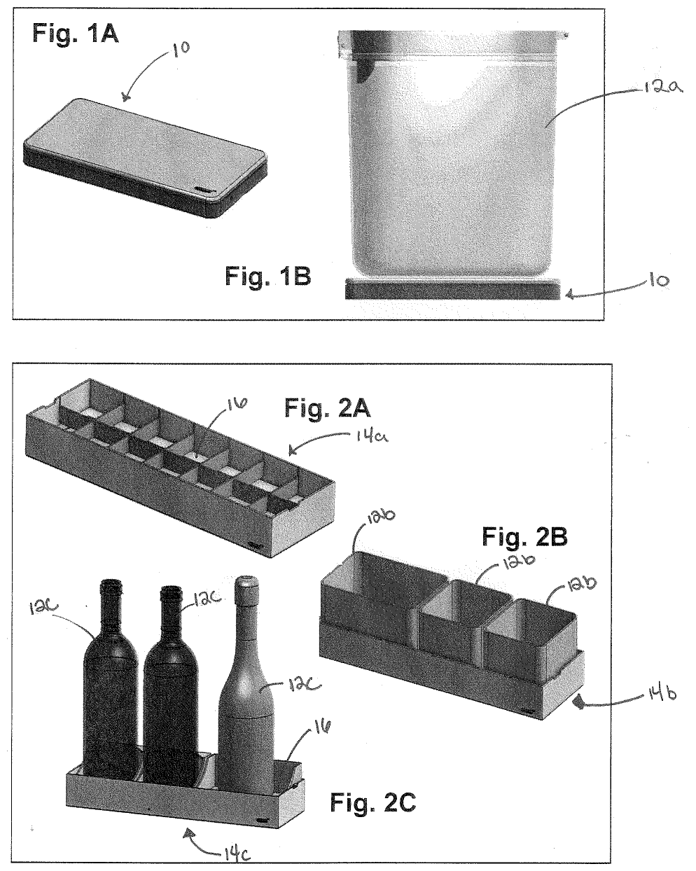

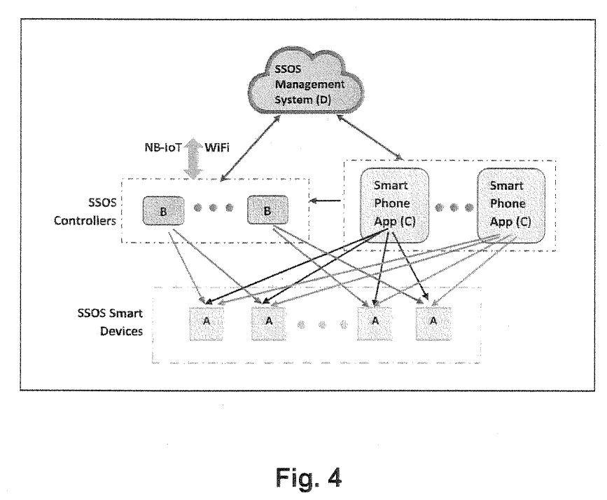

FIGS. 1A and 1B show a platform-type SSP 10. A container 12a located on top of the platform-type SSP 10 can be tracked and monitored by IoT sensors of an SSOS (see FIG. 4).

FIGS. 2A-2C show tray-type SSPs 14a, 14b, 14c which are able to accommodate multiple containers 12a, 12b, 12c. The example in FIG. 2A shows an SSP 14a station being divided into a number of partitions 16 which can be used for seating items such as eggs, bottles, pill containers, make up items, etc. FIG. 2B is an example showing several containers 12b seating on an SSP station 14b. The example in FIG. 2C illustrates an SSP station 14c serving as a smart wine rack to track and monitor the status of several bottles 12c of wine. IoT sensors of SSOS in this type of SSP station 14a, 14b, 14c are able to monitor and track the multiple containers 12a, 12b, 12c in the station 14a, 14b, 14c.

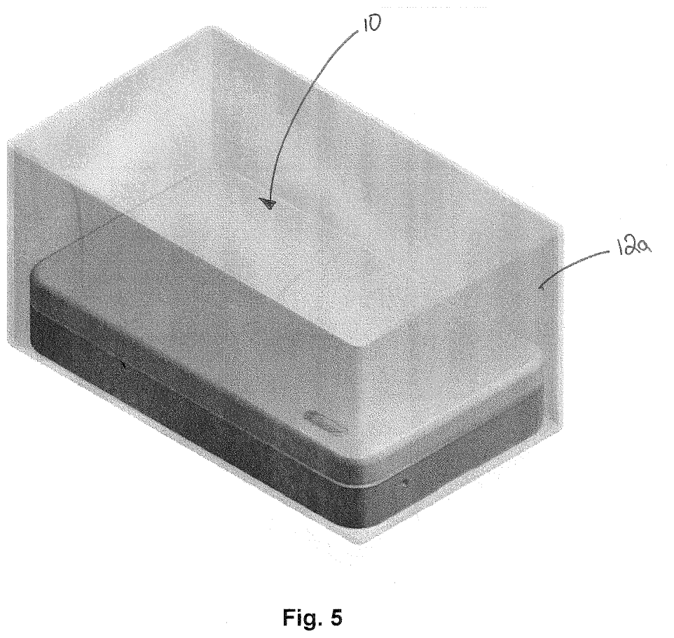

Though the use of containers 12a, 12b, 12c are disclosed for use with the platform-type SSP 10 and the tray-type SSP 14a, 14b, 14c, the platform-type SSP 10 and the tray-type SSP 14a, 14b, 14c are also configured to track and monitor the status of stored items without the use of containers 12a, 12b, 12c. Additionally, as shown in FIG. 5, the platform-type SSP 10 or the tray-type SSP 14a, 14b, 14c may be oriented (attached) within a given container 12a, 12b, 12c such that its contents are stored directly upon the platform-type SSP 10 or the tray-type SSP 14a, 14b, 14c.

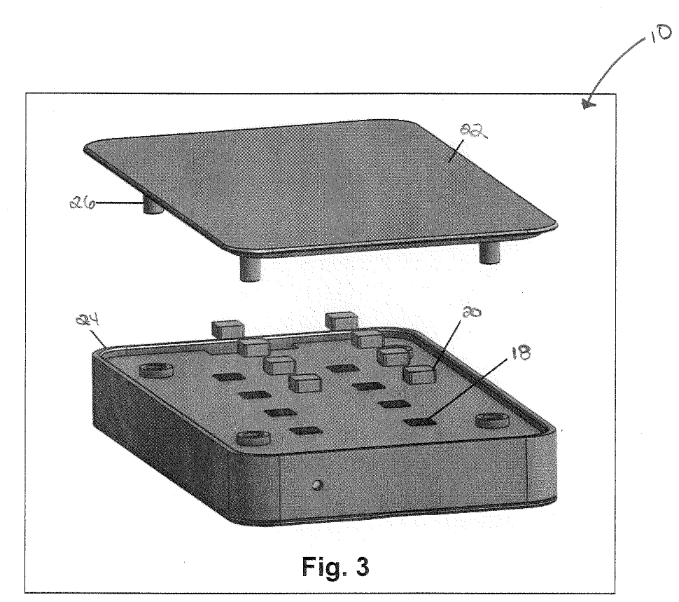

Shown in FIG. 3 is the mechanical structure of an SSP platform-type 10. It should be understood that the SSP tray-type 14a, 14b, 14c may include a mechanical structure which is substantially similar to the SSP platform-type 10, however, the mechanical structure will be discussed with reference to the SSP platform-type 10. Each SSP platform 10 is installed with a number of weight or pressure sensors 18. A corresponding number of soft pads 20 are positioned on a body (base) 24 beneath a top plate 22 of the SSP platform 10. The soft pads 20 may be connected to or integral to the body 24 but a person of ordinary skill in the art would understand that other attachment orientations may be compatible with the SSP platform 10. The soft pads 20 are preferably made of soft elastic materials with a specific durometer in hardness, e.g. silicone or TPE; the top plate 22 is preferably made of hard plastic material such as ABS, PP, etc. Maintaining alignment between the top plate 22 and the body 24 is preferable so that the soft pads 20 are always in contact with corresponding weight or pressure sensors 18.

When a container 12a is located on the top plate 22, the weight of the container 12a and its contents forces the top plate 22 and the soft pads 20 to exert pressure on the weight or pressure sensors 18. A corresponding controller of the weight or pressure sensors will then determine the load on the top plate 22. An SSOS Bluetooth beacon broadcasts the relevant container description and sensor data, including the weight information, to the SSOS controller and the SSOS mobile app (see FIG. 4). The electronic hardware (not shown), including the SSOS device and the weight sensor controller, are to be mounted in the body 24 of the SSP platform 10.

It is preferable that the top plate 22 be able to move up and down slightly in response to the variation in weight of the container 12a and contents. Guide posts 26 and similar construction/structure may be used to ensure the alignment between the top plate 22 and the body 24, as well as to ensure that the top plate 22 maintains its horizontal level so as to reduce the possible error in weight measurement due to friction and the inclined plane effect.

A fundamental element of the SSOS is a smart device (item A in FIG. 4) which is attached to the storage containers 12a, 12b, 12c. The smart device A is equipped with a Bluetooth low energy (BLE) beacon to provide information regarding the identification and location of the storage containers 12a, 12b, 12c and its contents. The beacon is integrated with sensors for monitoring the real-time status and condition of the storage contents. User-writable memory will be available for recording the identification and description of storage contents, and the updated sensory status.

Mobile phone apps (item C in FIG. 4) are provided to allow users to interact with the smart devices A to access the updated status of the storage contents.

A smart controller (item B in FIG. 4) may be used to communicate with a number of smart devices A, as well as smart phones via the corresponding apps C. The smart controller B also serves as the gateway for connecting to other IoT systems via the IoT wide area network (e.g. NB-IoT and WiFi).

An SSOS management software system (item D in FIG. 4) is installed in a cloud server or a PC. The SSOS management software system's D elementary functions include handling of the storage database and keeping records of the storage containers 12a, 12b, 12c and contents. The SSOS management software system D is linked via WiFi to smart controllers B and mobile apps C, to access and process the real-time status and condition recorded by the smart devices A. Advanced functions, such as big data analytics, Al and machine learning, etc., can be developed to enhance applicability.

The smart device A is an IoT-based device for identification and monitoring of storage items and their containers 12a, 12b, 12c and storage location. The smart device A acts as a beacon to support the location tracking function. The smart device will perform real-time monitoring of the storage. With regards to typical storage applications, the following three types of sensors will be available: temperature, humidity, and weight. The smart device A will provide a sufficient amount of user-writable memory (at least 1K) for recording relevant information of the storage (e.g. identification, description, status (such as expiry date) of the storage contents, and sensory records). The smart device A will actively communicate with the mobile phone apps C (for both iOS-based Apple iPhones or Android-based smart phones) and an optional SSOS controller B. It is preferable that there are means to connect the smart device A to an IoT wide area network (e.g. the optional SSOS controller B is connectable to the NB-IoT and WiFi). Alternatives for WAN connection can be employed. The smart device A is expected to be capable for monitoring food storage in different environments, including ambient storage, refrigerator or freezer. The smart device A will be completely sealed within a food-safe plastic enclosure which is FDA approved.

The SSOS Smart Controller B communicates with a number of (for instance, 8 or more) smart devices A within the local RF-reachable vicinity, with an easy hardware or software upgrade for accommodating more devices A. The SSOS controller B is able to communicate with smart phones via the corresponding mobile apps C. The SSOS controller B is linked up with a computer (or a cloud server, or a Smart Home Management System, etc.) to upload and download the relevant information regarding the storage containers 12a, 12b, 12c and the contents. The SSOS controller B can be connected to other IoT systems via the NB-IoT (narrow band IoT) wide area network and WiFi.

Mobile applications (Apps) C for smart mobile phones are available in both iOS and Android versions. The apps C interact with the smart devices A and the SSOS controller B, if available. The apps C detect the beacon signals from the smart devices A and the SSOS controller B within the reasonable vicinity. The apps C provide updated information and status of the storage contents. The apps C are able to send an alert to the user with regard to the pre-defined or real-time conditions (for instance, the identification and description of the content, the pre-defined expiry date, and the real-time sensory information). The apps C are able to support voice commands, with the provision to integrate with a common voice system (for instance, Amazon Alexa) for smart home applications. The apps C are able to record images and videos with the camera of the mobile phone, and to access the photos and videos in the mobile phone. The apps C are able to write information to the memory of the smart device A. The apps C are able to read data via 1-d and 2-d barcodes. The apps C also interact with the SSOS management system D which is to be installed in a PC or a cloud server. Information uploading and downloading, and basic data access functions have to be supported.

The SSOS Management System D is the software for handling the storage database. It is to be installed in a PC or a cloud server. The SSOS Management System D is responsible for handling the records on the real-time and historical status of the storage containers 12a, 12b, 12c and the storage locations. The SSOS Management System D interacts with the SSOS smart phone apps C and the optional SSOS controller B.

It will be appreciated that the SSP 10, 14a, 14b, 14c operates in conjunction with the SSOS to track information and update information on the contents of containers 12a, 12b, 12c and the storage location in real-time.

While the embodiment of the disclosed smart storage pallet has been set forth for purposes of illustration, the foregoing description should not be deemed a limitation of the invention. Accordingly, various modifications, adaptations and alternatives may occur to one skilled in the art without departing from the spirit of the disclosure and the scope of the claimed coverage.

1. A smart storage pallet (SSP) for operation with an smart storage and organizer system (SSOS) comprising a device communicable with a mobile application (app) and a controller comprising:
a base;
a platform mounted to the base;
a plurality of soft elastic pads mounted to the base in communication with a number of weight or pressure sensors and responsive to the weights received on the said platform;
a weight sensor controller responsive to a number of weight or pressure sensors for communicating data to the SSOS device and transmitting data to the mobile app and the SSOS controller wherein the data relates to information concerning weighed contents.

2. The SSP of claim 1 wherein the base and platform are made of a hard material chosen from a group consisting of plastic, wood, or metal.

3. The SSP of claim 1 wherein the soft pads are made of a soft elastic material of a specific durometer and hardness.

4. The SSP of claim 1 wherein the platform is in the form of a tray for housing multiple containers.

5. The SSP of claim 4 wherein each compartment is equipped with at least one weight or pressure sensor.

6. The SSP of claim 1 wherein the platform is configured as a smart wine rack structure.

7. The SSP of claim 1 wherein the platform is configured as an egg container.

8. The SSP of claim 1 wherein the platform is configured as a pill box.

9. The SSP of claim 1 further comprising the mobile apps handle sensing information with multiple compartments for docking multiple containers.

10. A smart storage pallet (SSP) for operation with an smart storage and organizer system (SSOS) comprising a device communicable with a mobile device and a controller comprising:
a body;
at least one partition dividing the body;
a plate mounted to the body at a position above the body;
at least one weight or pressure sensor included between the body and the plate;
a weight sensor controller responsive to the at least one weight or pressure sensor for communicating data to the SSOS device and transmitting data to the mobile device and the SSOS controller, wherein the data relates to information concerning items placed upon the plate.

11. A smart storage pallet (SSP) for operation with an smart storage and organizer system (SSOS) comprising a device communicable with a mobile application (app) and a controller comprising:
a container;
a base oriented within the container;
a platform mounted to the base;
a plurality of soft elastic pads mounted to the base in communication with a number of weight or pressure sensors and responsive to the weights received on the said platform;
a weight sensor controller responsive to a number of weight or pressure sensors for communicating data to the SSOS device and transmitting data to the mobile app and the SSOS controller wherein the data relates to information concerning weighed contents.
